(19) United States
(12) Patent Application Publication
(10) Pub. No.: US 2009/0186579 A1
(43) Pub. Date: Jul. 23, 2009

(54) WIRELESS HEADSET WITH CHARACTER MESSAGE OUTPUTTING FUNCTION AND METHOD FOR OUTPUTTING CHARACTER MESSAGE

(75) Inventors: YOUNG HO KIM, Seoul (KR); JOON HO KIM, Yongin-si (KR); JAE HO KANG, Yongin-si (KR)

Correspondence Address: KNOBBE MARTENS OLSON & BEAR LLP, 2040 MAIN STREET, FOURTEENTH FLOOR, IRVINE, CA, 92614, US

(73) Assignee: DREAM TECHNOLOGY CO., Seongnam-si (KR)

(21) Appl. No.: 12/358,040

(22) Filed: Jan. 22, 2009

(30) Foreign Application Priority Data
Jan. 23, 2008 (KR) 10-2008-0007108

(51) Int. Cl. H04B 7/00; H04M 1/00

(52) U.S. Cl. 455/41.2; 455/569.1

(57) ABSTRACT

A wireless headset with a character message outputting function and a method for outputting a character message are disclosed. The character message is output after being converted into a voice signal when a mobile communication terminal performing wireless connection with the wireless headset receives the character message. A user can confirm the character message through the voice signal using the wireless headset without directly confirming the character message in the mobile communication terminal, which allows the user to confirm the character message in the wireless headset while listening to the music.

### CROSS-REFERENCE TO RELATED APPLICATION

The present application claims priority to Korean Patent Application No. 10-2008-7108 filed on Jan. 23, 2008, the entire disclosure of which is incorporated herein by reference.

### BACKGROUND OF THE INVENTION

1. Field of the Invention

The present invention relates to a wireless headset with a character message outputting function and a method for outputting a character message. More particularly, the present invention relates to a wireless headset with a character message outputting function and a method for outputting a character message from the wireless headset, in which a character message is converted into a voice message when receiving the character message from a mobile communication terminal connected to the wireless headset, allowing a user to confirm the character message.

2. Description of the Related Art

Recently, mobile communication terminals such as cellular phones have begun to include various functions such as MP3 reproduction or the like as well as voice communication or short message service (SMS). Further, mobile communication terminals can perform wireless connection with a wireless headset (including earphones). In this case, a user can use the wireless headset as a hands free device or for listening to music in a state that the mobile communication terminal is in a bag.

At this time, radio communication between the mobile communication terminal and the wireless headset may be based on the Bluetooth (Institute of Electrical and Electronics Engineers (IEEE) 802.15.1) protocol.

When such a mobile communication terminal receives a character message, a process of notifying the character message arrival and outputting the character message is performed. Hereinafter, the process of notifying the character message arrival and outputting the character message will be described with reference to FIGS. 1 and 2.

FIG. 1 shows a general mobile communication terminal and a general wireless headset.

Referring to FIG. 1, a mobile communication terminal 10 performs wireless connection with a wireless headset 20 via the Bluetooth protocol or a similar protocol.

Then, the mobile communication terminal 10 sends a voice communication signal and a music reproduction signal to the wireless headset 20, enabling phone conversation and music listening through the wireless headset 20.

At this time, when the mobile communication terminal 10 receives the character message, the process of notifying the character message arrival or outputting the character message is performed as shown in FIG. 2, irrespective of whether the wireless headset 20 is currently worn.

FIG. 2 is a flowchart illustrating a method of outputting the character message in the mobile communication terminal of FIG. 1.

Referring to FIG. 2, the mobile communication terminal 10 determines whether the character message has arrived, in operation S11. If the character message has arrived, the mobile communication terminal 10 generates a sound or vibrates in operation S12. Then, if a user selects confirmation of the received character message in operation S13, the character message is displayed on a display unit in operation S14.

In this case, if the sound or the vibration for notifying the character message arrival is generated while music is reproduced, the music is stopped. Then, the music is reproduced again after the character message is confirmed.

Since the wireless headset performing wireless connection with the mobile communication terminal has no function of notifying the character message arrival when the character message is arrived, there is a problem that the headset cannot notify a user of the character message arrival even when the user wears the headset.

In other words, even in the case of wearing the headset, the user must see the mobile communication terminal such as the cellular phone to confirm the character message.

### SUMMARY OF THE INVENTION

The present invention is conceived to solve the problems of the conventional techniques as described above, and it is an aspect of the present invention to provide a wireless headset which receives a character message and converts the character message into a voice message when a mobile communication terminal connected to the wireless headset receives the character message, and a method for outputting a character message in the wireless headset.

In accordance with one aspect of the present invention, a wireless headset having a character message outputting function includes: a Bluetooth module performing wireless connection with a mobile communication terminal to send and receive an audio signal, a character message and a control signal to and from the mobile communication terminal; an audio processor to process the audio signal input from the Bluetooth module and to output the processed audio signal; a character-voice converter to convert character information of the character message input from the Bluetooth module into a voice signal; an output selection unit to selectively output the audio signal and the voice signal from the audio processor and the character-voice converter to a speaker; a key input unit to request the character message and to input a selection signal for controlling operations of the mobile communication terminal; and a controller to control operations of the Bluetooth module, to output the selection signal of the key input unit to the Bluetooth module according to selections of the key input unit, to control reception of the character message and the audio signal input from the Bluetooth module, and to control operations of the character-voice converter and the output selection unit.

The wireless headset may further include a display unit to display an operating state of the controller.

The display unit may include a light emitting diode (LED) to express the operating state with a plurality of colors, or a liquid crystal display (LCD) to express the operating state with characters or an image.

The wireless headset may further include a microphone to receive a voice of a user. Thus, a voice signal received through the microphone is sent to the mobile communication terminal through the Bluetooth module under control of the controller.

In accordance with another aspect of the present invention, a method for outputting a character message in a wireless headset performing wireless connection with a mobile communication terminal to perform a function of outputting an audio signal and a function of outputting the character message by converting a received character message into a voice signal, the method including: sending a character message arrival signal from the mobile communication terminal to the wireless headset when the mobile communication terminal receives a character message; generating a character message arrival sound by the wireless headset as the wireless headset receives the character message arrival signal; determining whether or not a user inputs a confirmation request for the character message after generating the character message arrival sound; sending a character message request signal to the mobile communication terminal if the confirmation request for the character message is input; sending a character message from the mobile communication terminal to the wireless headset when the mobile communication terminal receives the character message request signal; and outputting a voice signal into which the character message is converted by the wireless headset.

The outputting of the voice signal converted from the character message may include: interrupting output of the audio signal and outputting the converted voice signal.

The audio signal may include music or speech output from the mobile communication terminal.

### BRIEF DESCRIPTION OF THE DRAWINGS

The above and other objects, features and advantages of the present invention will become apparent from the following description of preferred embodiments given in conjunction with the accompanying drawings, in which:

FIG. 1 illustrates a general mobile communication terminal and a general wireless headset;

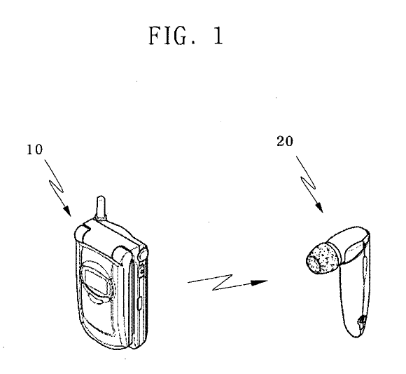

FIG. 2 is a flowchart illustrating a method for outputting a character message in the mobile communication terminal of FIG. 1;

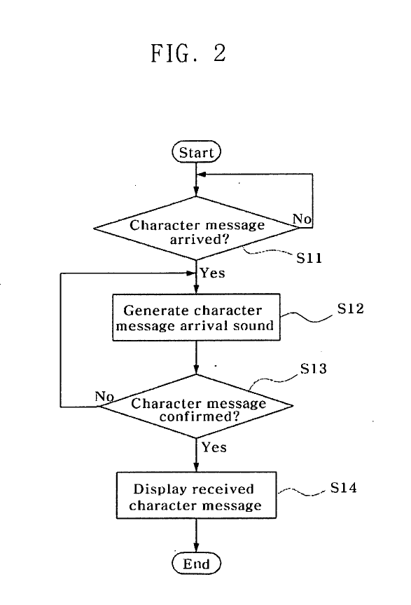

FIG. 3 is a block diagram of a wireless headset having a character message outputting function according to an exemplary embodiment of the present invention; and

FIG. 4 is a flowchart illustrating a method for outputting a character message in the wireless headset having the character message outputting function according to an exemplary embodiment of the present invention.

### DETAILED DESCRIPTION OF THE INVENTION

Exemplary embodiments of the present invention will be described in detail with reference to the accompanying drawings. It should be noted that the embodiments of the present invention are given by way of illustration only and do not limit the scope of the present invention, and that many modifications and changes can be made by a person having ordinary knowledge in the art without departing from the scope of the invention.

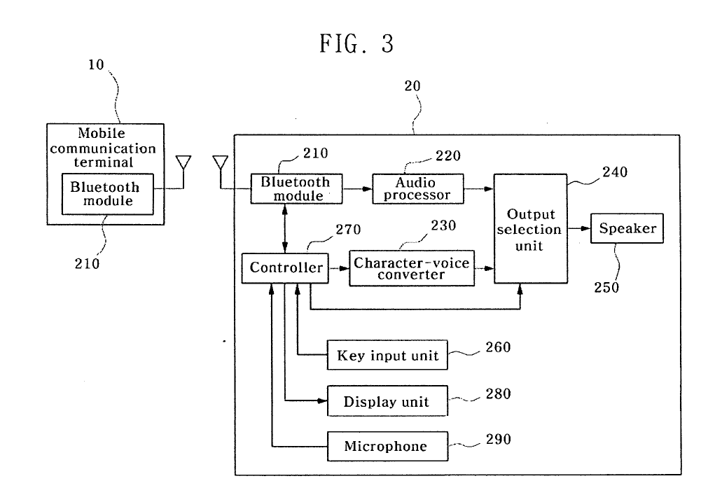

FIG. 3 is a block diagram of a wireless headset having a character message outputting function according to an exemplary embodiment of the present invention.

Referring to FIG. 3, a wireless headset 20 having a character message outputting function includes a Bluetooth module 210 which performs wireless connection with a mobile communication terminal 10 to send and receive an audio signal, a character message and a control signal to and from the mobile communication terminal 10; an audio processor 220 which processes the audio signal input from the Bluetooth module 210 and outputs the processed audio signal; a character-voice converter 230 which converts character information of the character message input from the Bluetooth module 210 into a voice signal; an output selection unit 240 which selectively outputs the audio signal and a voice signal from the audio processor 220 and the character-voice converter 230 to a speaker 250; a key input unit 260 used for requesting the character message and inputting a selection signal to control operations of the mobile communication terminal 10; and a controller 270 which controls operations of the Bluetooth module 210, outputs the selection signal of the key input unit 260 to the Bluetooth module 210 according to selections of the key input unit 260, controls reception of the character message and the audio signal input from the Bluetooth module 210, and controls operations of the character-voice converter 230 and the output selection unit 240.

Further, the wireless headset 20 may include a display unit 280 such as a light emitting diode (LED) to express an operating state of the controller 270 with a plurality of colors, a liquid crystal display (LCD) to express the operating state of the controller 270 with characters or an image, thereby notifying an output or arrival state of the character message.

Additionally, the wireless headset 20 may include a microphone 290 to receive a voice of a user so as to be used as a hands free module while performing wireless connection with the mobile communication terminal 10. Thus, the voice signal input from the microphone 290 is sent to the mobile communication terminal 10 through the Bluetooth module 210 under control of the controller 270, thereby enabling phone conversation.

With this configuration, the wireless headset 20 having the character message outputting function receives a character message arrival signal generated when the mobile communication terminal 10 receives the character message in a state that the wireless headset 20 performs wireless connection with the mobile communication terminal 10 through the Bluetooth module 210, thereby outputting the character message arrival sound. Further, when a user inputs a confirmation request signal through the key input unit 260, the wireless headset 20 sends a character message request to the mobile communication terminal 10, so that the received character message can be converted into a voice signal through the character-voice converter 230 and output to the speaker 250.

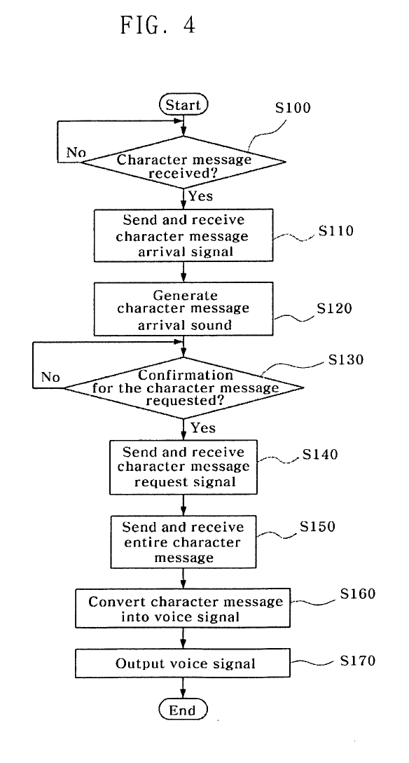

A method for outputting a character message in the wireless headset having the character message outputting function will hereinafter be described in detail with reference to FIG. 4.

In the wireless headset 20 that performs wireless connection with the mobile communication terminal 10 through the Bluetooth module 210 to perform a function of outputting an audio signal such as music or speech and a function of outputting a character message by converting the received character message into a voice signal, if the mobile communication terminal 10 receives the character message in operation S100, the mobile communication terminal 10 sends a character message arrival signal to the wireless headset 20 in operation S110.

When receiving the character message arrival signal from the mobile communication terminal 10, the wireless headset 20 outputs a character message arrival sound in operation S120.

After outputting the character message arrival sound, the wireless headset 20 determines whether a user inputs a confirmation request for the character message, in operation S130.

If the confirmation request for the character message is input, the wireless headset 20 sends a character message request signal to the mobile communication terminal 10 in operation S140.

Then, the mobile communication terminal 10, which receives the character message request signal, sends the whole character message to the wireless headset 20 in operation S150.

Then, the wireless headset 20 receives the character message and converts it into a voice signal in operation S160 and outputting the voice signal in operation S170.

Meanwhile, if the character message is output as the converted voice signal while music is reproduced, the output of the music is selectively switched, thereby allowing a user to listen to the music after outputting the voice signal converted from the character message.

As apparent from the above description, according to the present invention, a character message is output after being converted into a voice signal when the mobile communication terminal performing wireless connection with the wireless headset receives the character message, so that a user can confirm the character message through the voice signal in the wireless headset without directly confirming the character message on the mobile communication terminal. Accordingly, the user can confirm the character message using the wireless headset while listening to music.

The embodiments of the present invention have been disclosed above for illustrative purposes. Those skilled in the art will appreciate that various modifications, additions and substitutions are possible, without departing from the scope and spirit of the invention as disclosed in the accompanying claims.

1. A wireless headset having a character message outputting function, comprising:
a Bluetooth module performing wireless connection with a mobile communication terminal to send and receive an audio signal, a character message and a control signal to and from the mobile communication terminal;
an audio processor to process the audio signal input from the Bluetooth module and to output the processed audio signal;
a character-voice converter to convert character information of the character message input from the Bluetooth module into a voice signal;
an output selection unit to selectively output the audio signal and the voice signal from the audio processor and the character-voice converter to a speaker;
a key input unit to request the character message and to input a selection signal for controlling operations of the mobile communication terminal; and
a controller to control operations of the Bluetooth module, to output the selection signal of the key input unit to the Bluetooth module according to selections of the key input unit, to control reception of the character message and the audio signal input from the Bluetooth module, and to control operations of the character-voice converter and the output selection unit.

2. The wireless headset according to claim 1, further comprising:
a display unit to display an operating state of the controller.

3. The wireless headset according to claim 2, wherein the display unit comprises a light emitting diode (LED) to express the operating state with a plurality of colors, or a liquid crystal display (LCD) to express the operating state with characters or an image.

4. The wireless headset according to claim 1, further comprising:
a microphone to receive a voice of a user and to send a received voice signal to the mobile communication terminal through the Bluetooth module under control of the controller.

5. A method of outputting a character message in a wireless headset performing wireless connection with a mobile communication terminal to perform a function of outputting an audio signal and a function of outputting the character message by converting a received character message into a voice signal, the method comprising:
sending a character message arrival signal from the mobile communication terminal to the wireless headset when the mobile communication terminal receives a character message;
generating a character message arrival sound through the wireless headset when the wireless headset receives the character message arrival signal;
determining whether or not a confirmation request for the character message is input by a user, after generating the character message arrival sound;
sending a character message request signal to the mobile communication terminal if the confirmation request for the character message is input;
sending a character message from the mobile communication terminal to the wireless headset when the mobile communication terminal receives the character message request signal; and
outputting a voice signal into which the character message is converted by the wireless headset.

6. The method according to claim 5, wherein the outputting of the voice signal converted from the character message comprises interrupting output of the audio signal and outputting the converted voice signal.

7. The method according to claim 5, wherein the audio signal comprises music or speech output from the mobile communication terminal.

8. The method according to claim 6, wherein the audio signal comprises music or speech output from the mobile communication terminal.
